(19) United States
(12) Patent Application Publication
(10) Pub. No.: US 2003/0086690 A1
(43) Pub. Date: May 8, 2003

(54) Storage medium having preloaded font information, and apparatus for and method of reproducing data from storage medium

(75) Inventors: Hyun-Kwon Chung, Gyeonggi-do (KR); Jung-Wan Ko, Gyeonggi-do (KR); Kil-soo Jung, Gyeonggi-do (KR); Byung-Jun Kim, Gyeonggi-do (KR); Bong-gil Bak, Seoul (KR)

Correspondence Address: STAAS & HALSEY LLP, 700 11TH STREET, NW, SUITE 500, WASHINGTON, DC, 20001, US

(73) Assignee: Samsung Electronics Co., Ltd.

(21) Appl. No.: 10/172,500

(22) Filed: Jun. 17, 2002

(30) Foreign Application Priority Data
Jun. 16, 2001 (KR) 2001-34138
Nov. 1, 2001 (KR) 2001-67827
Feb. 23, 2002 (KR) 2002-9744

(51) Int. Cl. H04N 5/781

(52) U.S. Cl. 386/69; 386/70; 386/125

(57) ABSTRACT

An interactive optical storage medium, an apparatus for and a method of reproducing data from the interactive optical storage medium. The interactive optical storage medium includes A/V data including audio or video data, and interactive data, which forms an interactive screen and includes a command to preload fonts relating to a content of the interactive screen into a memory of a reproducing apparatus during a seamless reproduction of the AV data. A font to be used is preloaded into the memory of the reproducing apparatus before an AV data screen of A/V data and a content screen of the interactive data, which are simultaneously reproduced in the interactive screen, are changed into a new interactive screen, thereby assuring the seamless reproduction of the A/V data screen.

### CROSS-REFERENCE TO RELATED APPLICATIONS

This application claims the benefit of Korean Application Nos. 2001-34138, 2001-67827, 2002-9744, filed Jun. 16, 2001, Nov. 1, 2001, Feb. 23, 2002, respectively, in the Korean Industrial Property Office, the disclosure of which is incorporated herein by reference.

### BACKGROUND OF THE INVENTION

1. Field of the Invention

The present invention relates to an interactive optical information storage medium and an apparatus for and a method of reproducing data from the interactive optical storage medium, and more particularly, to an interactive optical information storage medium having preloaded font information, audio/video data, and interactive data, and an apparatus for and a method of reproducing the interactive optical storage medium.

2. Description of the Related Art

In general, audio/video (A/V) contents and user definition information are recorded on an optical information storage medium. The A/V contents are multimedia data having predetermined specifications provided by the optical information storage medium, and the user definition information containing additional supplementary contents is defined by a content manufacturer. The optical information storage medium provides only A/V contents through a predetermined reproducing apparatus, and the user definition information can be accessed and available through a computer.

Recently, an optical information storage medium has been introduced to output network-linked interactive contents on a screen and to be operable in an environment based on web documents, and this optical information storage medium is referred to as an interactive optical storage medium. Contents recorded on the interactive optical storage medium can be reproduced by two modes, that is, a conventional A/V mode, which reproduces only conventional A/V contents, and an interactive mode, which provides the A/V contents and the user definition information in a web environment. When a user selects the interactive mode, an apparatus for reproducing data from the optical storage medium reads the web documents recorded on the interactive optical storage medium and outputs a web-based screen. That is, A/V data and interactive data are simultaneously output on the web-based screen.

When the A/V contents relate to a movie, the movie runs on the web-based screen, and simultaneously the user can view interactive contents containing various other information related to the movie and generating from the optical information storage medium or via network links. Other information may be any kind of information, such as graphic image files, text files, or audio files.

FIG. 1 is a schematic view of a conventional interactive optical information storage medium. Referring to FIG. 1, an interactive digital versatile disc (DVD), which is a kind of the interactive optical storage medium, includes a control information region 100, an A/V data region 110, and a DVD interactive data region 120.

DVD volume information and file information are recorded in the control information region 100. Audio data and video (AV) data as moving picture experts group (MPEG) bit streams and reproduction information for reproducing the audio data and the video data are recorded in the A/V data region 110.

Data related to the web documents such as hypertext markup language (HTML) documents, which provide the web environment of the web documents, are recorded in the DVD interactive data region 120. The data related to the web documents are web resources including a variety of image files and audio files, which are inserted into the web documents. Besides these regions, others 130 in which additional supplementary information for a user is recorded, may be further included in the optical information storage medium.

FIG. 2 illustrates an apparatus for reproducing information from the DVD shown in FIG. 1. Referring to FIG. 2, a DVD reading module 200 reads data recorded on the DVD. A modem 202 receives the web documents via external networks. Web contents (web documents) received via the external networks may be used in an interactive operation environment, like web contents recorded in the interactive data region of the DVD.

A signal processor 204 processes and stores DVD signals (the read data) output from the DVD reading module 200 and web contents received by the modem 202 via external networks. A video processor 206 processes only video signals among signals processed by the signal processor 204 and outputs the processed video signals on a screen output unit 208.

An audio processor 210 processes only audio signals among the signals processed by the signal processor 204 and outputs the processed audio signals to a speaker 212.

FIG. 3 illustrates a software layer model of the apparatus shown in FIG. 2. Referring to FIG. 3, a web contents layer 300 outputs the web contents received via networks, or disc contents stored in the optical information storage medium.

The disc and web contents may include A/V data, audio data, graphic images, JAVA applet, HTML, or XML.

An application layer 310 supports a plug-in function and includes engines (JAVA engines or basic web browsers) operating document files of the web contents.

An application programming interface (API) layer 320 makes a connection between a lower portion of a hardware layer (operating system) 330 and a upper portion of a software layer (processing engine) 340 according to a specific protocol.

FIG. 4 illustrates an example of an interactive DVD screen. Referring to FIG. 4, the interactive DVD screen includes an A/V data screen region 400 in which the A/V data are reproduced, and an interactive data screen region 410 in which interactive data are reproduced. In general, the interactive DVD screen is similar to a shape (frame) of a web browser screen. When the A/V data are reproduced in the A/V data screen region 400, the interactive data for additionally serving the reproduced A/V data to a user are output on the interactive data screen region 410. The interactive data screen region 410 is formed using the web documents, such as HTML documents, and thus has an interactive function of reproducing, controlling the A/V data as well as providing other information, such as information searched via networks and web site linking.

Conventional apparatuses for reproducing information from the interactive DVD have limitations in capacity of an internal memory. Thus, all fonts related to various letter types used for outputting the interactive data stored in the interactive DVD on the interactive DVD screen cannot be stored in an internal memory of the apparatus. That is, the fonts, which are basically used in an interactive data screen, require a memory capacity of about 1.5 megabytes, when Korean and Chinese characters are included. When various fonts, such as MingJo and Gothic, are further used in the interactive data screen, a required amount of the memory capacity becomes larger, and thus there are limitations in the memory capacity to store all fonts in the internal memory of the apparatus.

The apparatus stores and uses only minimum built-in fonts, and if necessary, reads (or loads) other fonts used for outputting the interactive data stored in the interactive DVD on the interactive DVD screen. The method of loading the fonts and an apparatus for reproducing the interactive DVD implemented by this method may load a new font whenever a new interactive data screen is output. In a case of a seamless reproduction of the information in which the interactive data screen is automatically changed during the AV data reproduction, the interactive data for the newly output interactive data screen must be loaded from the interactive DVD into the internal memory of the apparatus. However, since it takes time to load the fonts, the change of the A/V data screen is delayed due to the time taken to load the fonts, and an interruption of the seamless reproduction of the AV data occurs.

### SUMMARY OF THE INVENTION

To solve the above and other problems, it is an object of the present invention to provide an interactive optical storage medium having preloaded font information so as to prevent interruption of seamless reproducing of A/V data.

It is another object of the present invention to provide an apparatus for and a method of reproducing data stored on an interactive optical storage medium having preloaded information.

Additional objects and advantages of the invention will be set forth in part in the description which follows and, in part, will be obvious from the description, or may be learned by practice of the invention.

Accordingly, to achieve the above and other objects, according to an embodiment of the present invention, there is provided an interactive optical storage medium. The medium includes A/V data including audio or video data, and interactive data which constitutes a predetermined interactive screen having a display screen displaying a video picture corresponding to the A/V data and includes a command to preload fonts for use in a plurality of interactive screens into a memory of a reproducing apparatus during seamless reproduction of the AV data.

According to an another aspect of the present invention, the interactive data are web-based documents.

According to an aspect of the present invention, the interactive data includes a command to preload font data for use in a subsequent interactive screen into the present interactive data during the seamless reproduction.

According to another aspect of the present invention, a font identifier (ID) of a font to be preloaded is provided in the preload information when performing command to preload the font data.

According to another aspect of the present invention, a font-range of a font to be preloaded is provided in the preload information when performing the command to preload the font data.

According to another aspect of the present invention, the font-range of the font is defined using a letter code which is stipulated according to an ISO 10646 standard.

According to another aspect of the present invention, attribute information of a font to be preloaded is provided in the preload information when performing the command to preload the font data.

According to another aspect of the present invention, the attribute information of the font includes font-family (representing a group in which the font is included, and a font name), font-style (representing the style of the font), font-variant (representing whether or not the font can be represented as a bold type), font-weight (representing the thickness of the font), font-stretch (representing the aspect ratio of the font), and font-size (representing the size of the font).

According to another aspect of the present invention, the medium further includes a discard command for removing a loaded font.

According to another aspect of the present invention, the discard command is a command for designating the path and name of a font file and removing them.

According to another aspect of the present invention, the discard command is a command for removing a font having a corresponding ID by designating a font ID.

To achieve the above and other objects, according to another embodiment of the present invention, there is provided an interactive optical storage medium. The medium includes an A/V data region in which audio or video data is recorded, an interactive data region in which a predetermined interactive screen displaying a video picture corresponding to the A/V data is constituted and a command to preload fonts for use in a plurality of interactive screens into a memory of a reproducing apparatus during the seamless reproduction is included, and an interactive data-copying region in which the same data as interactive data information region are stored to compensate for damage in the interactive data.

To achieve the above and other objects, according to another embodiment of the present invention, there is provided an apparatus for reproducing data from an interactive optical storage medium. The apparatus includes a first memory storing A/V data read from the interactive optical storage medium, a second memory storing interactive data read from the interactive optical storage medium, an A/V data decoder decoding the A/V data stored in the first memory, and an interpreting engine interpreting the interactive data from the second memory and outputting the interpreted interactive data on a screen. Here, the second memory takes fonts to be preloaded from the interactive optical storage medium and stores the fonts when the interpreting engine requests the second memory to perform a preload function in response to a preload command.

According to another aspect of the present invention, the interactive data includes a command for preloading font data for use in a subsequent interactive screen into the present interactive data during seamless reproduction.

According to another aspect of the present invention, the A/V data decoder is a moving picture experts group (MPEG) decoder which decodes A/V data compressed in the format of MPEG.

According to another aspect of the present invention, the fonts stored in the second memory according to the preload command, are fonts for use in a subsequent screen after the present interactive screen.

To achieve the above and other objects, according to another embodiment of the present invention, there is provided a system for reproducing data from an interactive optical storage medium. The system includes an interactive optical storage medium on which interactive data having a preload command and A/V data are recorded, a first memory reading the A/V data from the interactive optical storage medium and storing the A/V data, a second memory reading the interactive data from the interactive optical storage medium and storing the interactive data, a decoder decoding the A/V data from the first memory, an interpreting engine interpreting the interactive data from the second memory and providing interactive screen data, and a screen output unit, which forms a screen according to the interactive screen data received from the interpreting engine, synthesizes the A/V data received from the decoder, with the interactive screen data in the screen and outputs the result of synthesis. Here, the second memory takes fonts to be preloaded from the interactive optical storage medium and stores the fonts when the interpreting engine requests to perform a preload command.

According to another aspect of the present invention, the screen output unit provides a moving picture screen region in which the decoded A/V data are reproduced, and a screen region in which network searching and linking and an interactive operation are performed.

To achieve the above and other objects, according to another embodiment of the present invention, there is provided a method of reproducing data from an interactive optical storage medium having preloaded font information. The method includes reading a control information file having information constituting an initial interactive screen from the interactive optical storage medium, loading fonts, which are defined by displayable languages and by the kind of basic fonts of the control information file, into a memory, reading a data file of an interactive screen to be output, reading an indicated preload file when a preload command is included in the data file of the interactive screen and loading fonts, which are defined by the preload file, into the memory of a reproducing apparatus, outputting data of the interactive screen according to the data file of the interactive screen, and synthesizing a screen in which A/V data are reproduced, with the interactive screen and outputting the result of synthesis.

According to another aspect of the present invention, the method further includes removing a corresponding font from the second memory when the interactive data includes a discard command for removing a loaded font.

To achieve the above and other objects, according to another embodiment of the present invention, there is provided a method of preloading fonts stored in an interactive optical storage medium into an apparatus for reproducing data from the interactive optical storage medium. The method includes reading data file of an interactive screen from the interactive optical storage medium, checking whether a preload command is included in the data file of the interactive screen and reading fonts to be preloaded from the interactive optical storage medium and loading the fonts into a memory of the apparatus for reproducing data from the interactive optical storage medium when the fonts to be preloaded are included in the data file of the interactive screen, outputting a screen of interactive data, and removing the fonts from the memory when the fonts is requested to be discarded.

To achieve the above and other objects, according to another embodiment of the present invention, there is provided an interactive optical storage medium. The medium includes a first table which defines displayable languages when a screen of interactive data is output, a second table, which defines languages for use in the screen of the interactive data, which corresponds to languages for use in a screen of A/V data, and a third table which defines basic fonts to be used by the first languages defined by the first table.

According to another aspect of the present invention, the second table includes control information which automatically selects one from of the displayable languages defined by the first table when a language for use in the screen of A/V data and a language for use in the screen of interactive data are not defined by the first table.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a schematic view of a conventional interactive optical information storage medium;

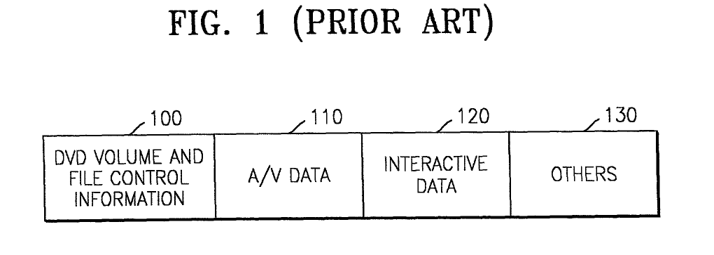

FIG. 2 illustrates an apparatus for reproducing information from the interactive DVD shown in FIG. 1;

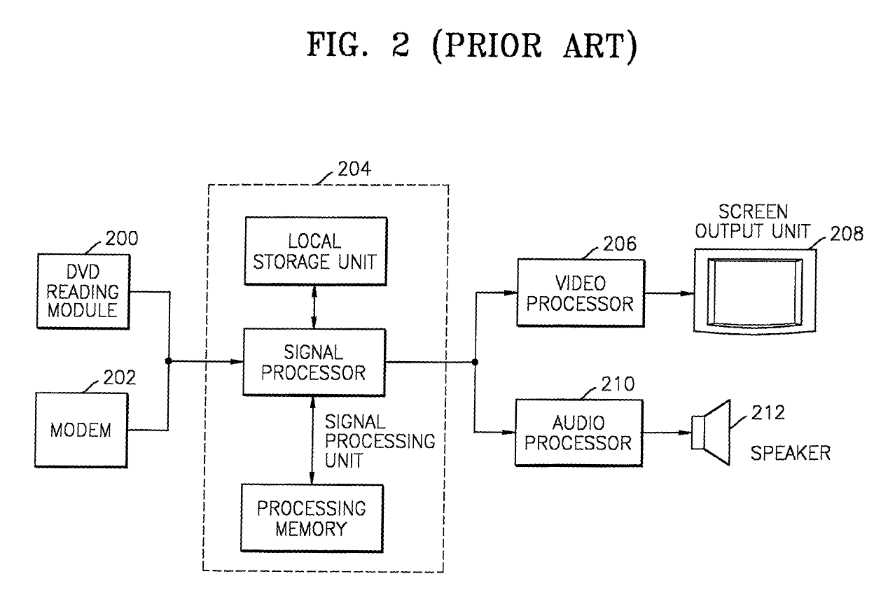

FIG. 3 illustrates a software layer model of the apparatus shown in FIG. 2;

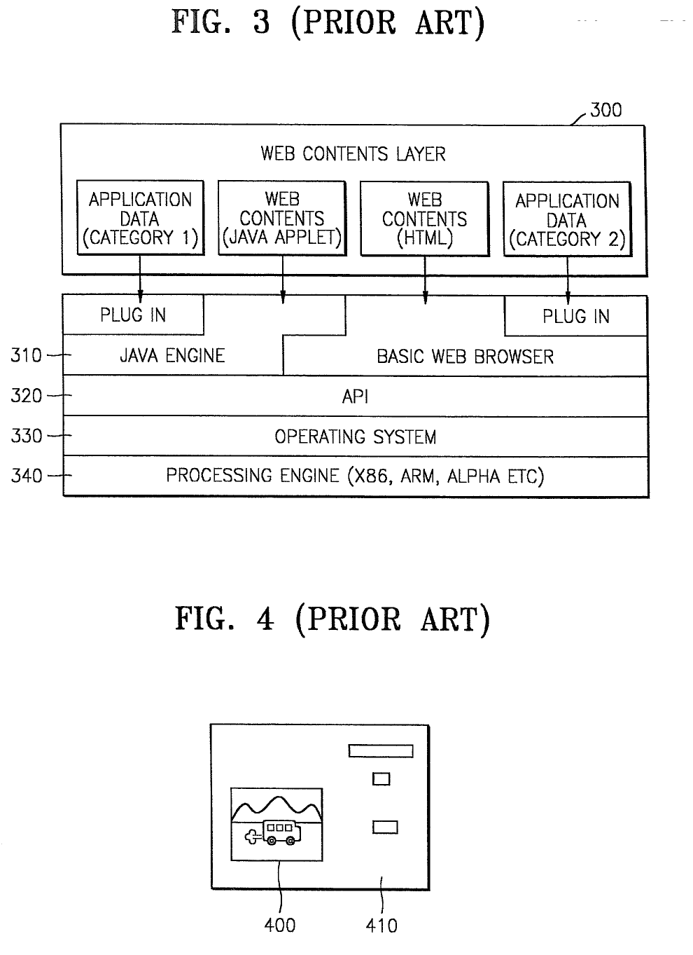

FIG. 4 illustrates an example of an interactive DVD screen;

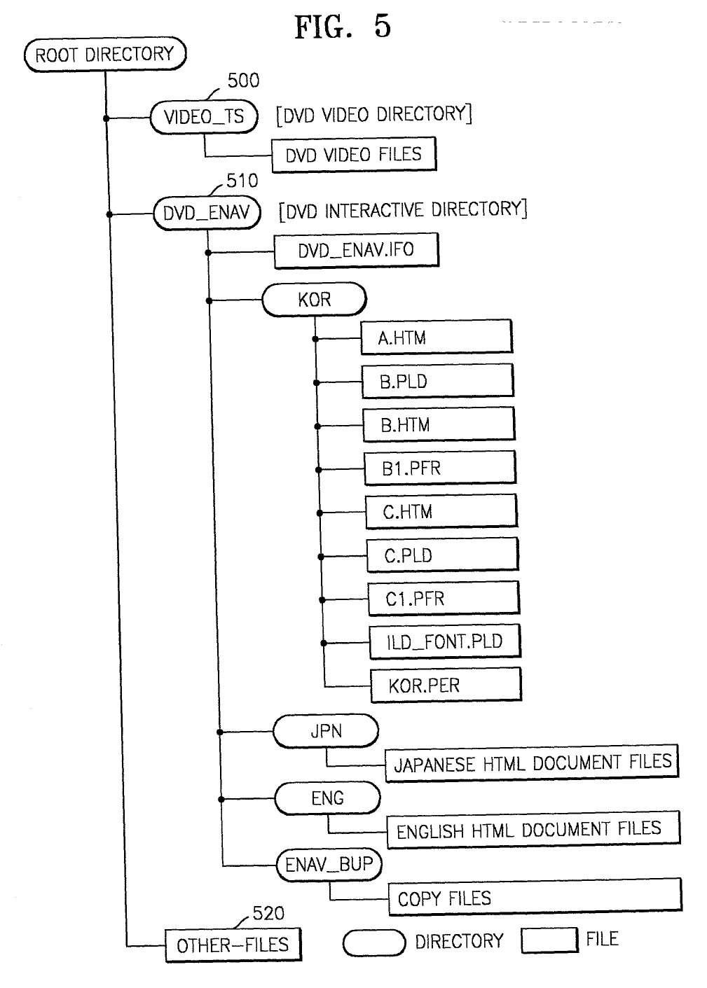

FIG. 5 illustrates a directory structure of an interactive optical storage medium having preloaded font information according to an embodiment of the present invention;

FIGS. 6A and 6B are tables illustrating displayable languages and an example of basic font indication information, which are defined by an interactive navigation file DVD_ENAV. IFO of FIG. 5;

FIG. 7 is an example of seamless interactive screens A, B, and C reproduced in accordance with the preloaded font information of FIG. 5;

FIG. 8 illustrates a volume space of the interactive optical storage medium having the preloaded font information of FIG. 5;

FIG. 9 illustrates a reproducing apparatus reproducing the preloaded font information from an interactive optical storage medium according to another embodiment of the present invention;

FIGS. 10A and 10B are flow charts illustrating a method of operating an interactive optical storage medium having the preloaded font information in the reproducing apparatus of FIG. 9; and

FIGS. 11A and 11B are flow charts illustrating a method for loading fonts stored in the interactive optical storage medium into the reproducing apparatus of FIG. 9.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

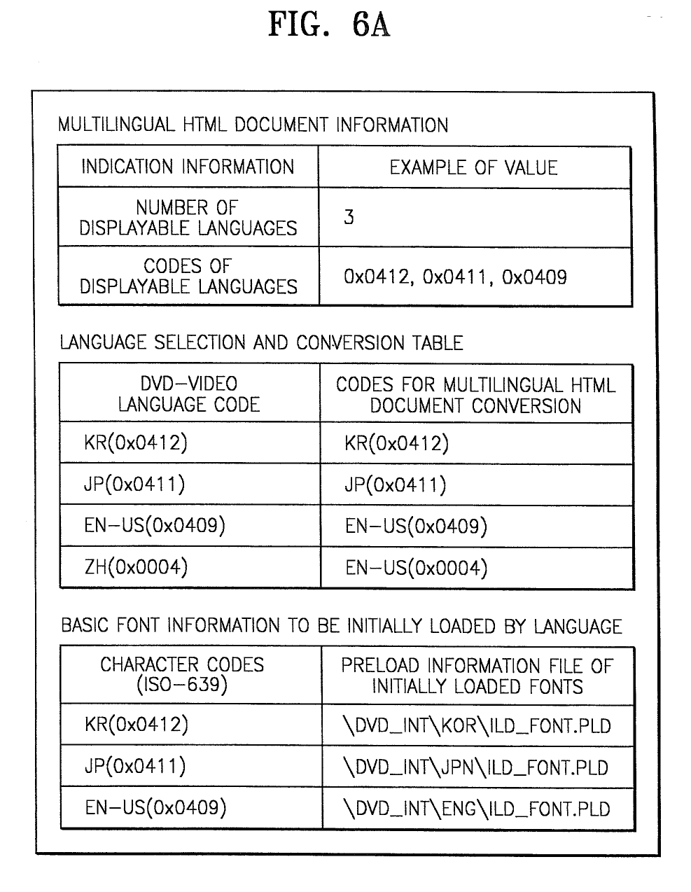

FIG. 5 illustrates a structure of a root directory of an interactive optical storage medium having preloaded font information according to an embodiment of the present invention. Referring to FIG. 5, the interactive optical storage medium having the preloaded font information includes a video data directory 500 having A/V data, which are substantially reproduced in an interactive data screen, and reproduction information for reproducing the A/V data, an interactive data directory 510 used for outputting interactive data on the interactive data screen, and other files 520 having other optional information.

A reproducing control information file having the reproduction information for controlling files used for reproducing video/audio information, a video title set managing file, a video title menu file, and an A/V file to be reproduced are included in the video data directory 500.

Data files composing an interactive data screen are included in the interactive data directory 510. It is assumed that the data files comprising the interactive data screen are written in an HTML language and there are output screens (interactive data screens) A, B, and C. Further, it is assumed that a seamless reproduction are simultaneously performed on the output screens A and B including an A/V data reproduction picture, and the output screen C is selected by a user or according to a system.

A control information file (i.e., DVD_ENAV. IFO) having control information used for constituting an initial interactive screen is included in the interactive data directory 510.

Further, an HTML file (i.e., A.HTM) having data of the output screen A in relation to video reproduction information, a control information file (B.PLD) having preloaded information of data of the output screen B, an HTML file (B.HTM) having the data of the output screen B, an HTML file (C.HTM) having data of the output screen C, a control information file (C.PLD) having preloaded information of data of the output screen C, and a font file (C1.PER) for use in the data of the output screen C are included in the interactive data directory 510. There may also be files, such as files for outputting the interactive data on the interactive data screen according to displayable languages. In such a case, for example, when constituting a Korean displayable interactive data screen, a control information file (i.e, ILD_FONT.PLD) for reading basic fonts to be initially loaded and a Korean font file (KOR.PFR) can be further included in the interactive data directory 510. Information related to displayable languages is also included in the DVD_ENAV.IFO.

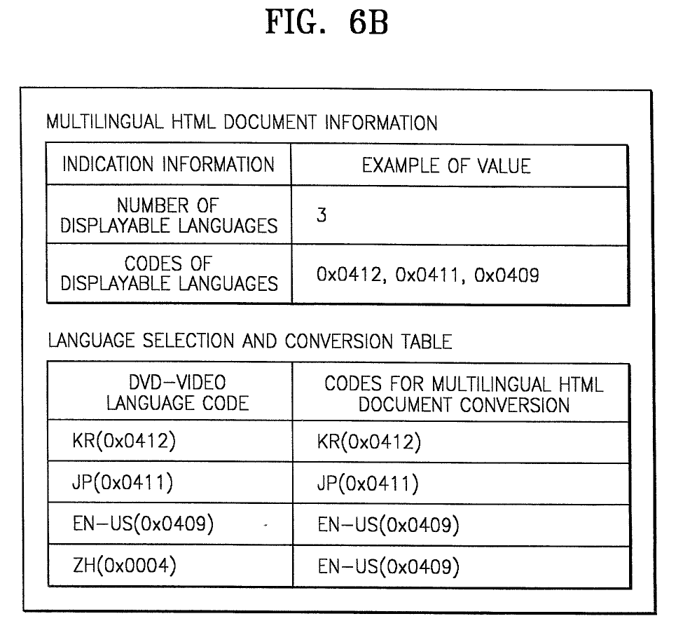

FIG. 6A is an example of a table illustrating the displayable languages and an example of basic font indication information defined in the DVD_ENAV. IFO of FIG. 5. Information related to the displayable languages, languages to be output on the interactive data screen in relation to the A/V data, and the basic font indication information for use in the interactive data screen are included in the control information used for constituting the initial interactive screen.

Referring to FIG. 6A, three languages are displayable in a multilingual HTML document support indication information of the DVD_ENAV.IFO. This means that there are three displayable languages in the interactive data screen. Codes for the displayable languages are 0x0412, 0x0411, and 0x0409 and are Korean, Japanese, and English codes, which are stipulated according to an ISO-639 standard. This means that Korean, Japanese, and English can be displayed when the interactive data screen is output.

A Korean code KR(0x0412), a Japanese code JP(0x0411), an English code EN-US(0x0409), and a Chinese code ZH(0x0004), which are used in subtitles of a DVD video screen of the interactive data screen, and language codes to be output on the interactive data screen according to the languages are defined in a language selection and conversion table. The languages displayable according to the subtitles are output on the interactive data screen. Referring to the table shown in FIG. 6A, it is noted that the language of the corresponding interactive data screen is defined as English in a case that Chinese is used in the subtitle.

Character codes KR(0x0412), JP(0x0411), and EN-US(0x0409) to be used in the interactive data screen, and the basic font information to be initially loaded according to the character codes defines a language to be initially loaded.

FIG. 6B is a table illustrating that there are only displayable language information in the DVD_ENAV.IFO when the basic fonts are defined in an HTML document in the format of an embedded font @font_face. When the basic fonts are in the HTML document in the format of the embedded font, the basic font information to be initially loaded shown in FIG. 6A will be omitted.

In a case of the interactive data screen using Korean, an example of the control information file ILD_FONT.PLD for reading the basic fonts is as follows.

?xml version=“1.0”? encoding=“UTF-8” ?>
<!DOCTYPE preload PUBLIC“-//DVD//DTD DVD Preload List 1.0//EN”
“http://www.dvdforum.org/enav/dtd/dvdhtml-preload-list.mod”>
<preload>
<fontdef id=“CBAEFOC1B42F11d5A48000D0B7DB671A”
font-family=“kor-gulim; arial” type=“application/dvd.pfr”
src=“dvd://dvd_enav/kor/kor.pfr”/>
</preload>

Information defining a resource of fonts to be loaded is included in the ILD_FONT.PLD and corresponds to a unique identifier (ID) of a corresponding font. A font-family is described in a format of “actual name; family name”. When the family name is included in the ILD_FONT.PLD and an apparatus for reproducing information from the interactive optical storage medium does not have a font corresponding to ‘actual name’, the apparatus can replace a present font with another font, which belongs to the same group as that of ‘family name’ and is stored in the memory of the apparatus. When the control information file is read, the apparatus loads the font defined in the above-mentioned information of the resource of the fonts into its own memory. After the font is loaded, the data of the interactive data screen is read. After the interactive data screen is formed, files (hereinafter, HTML files) indicating the output screens A, B, or C in which the A/V data of the interactive optical storage medium are reproduced and simultaneously output, are read and performed.

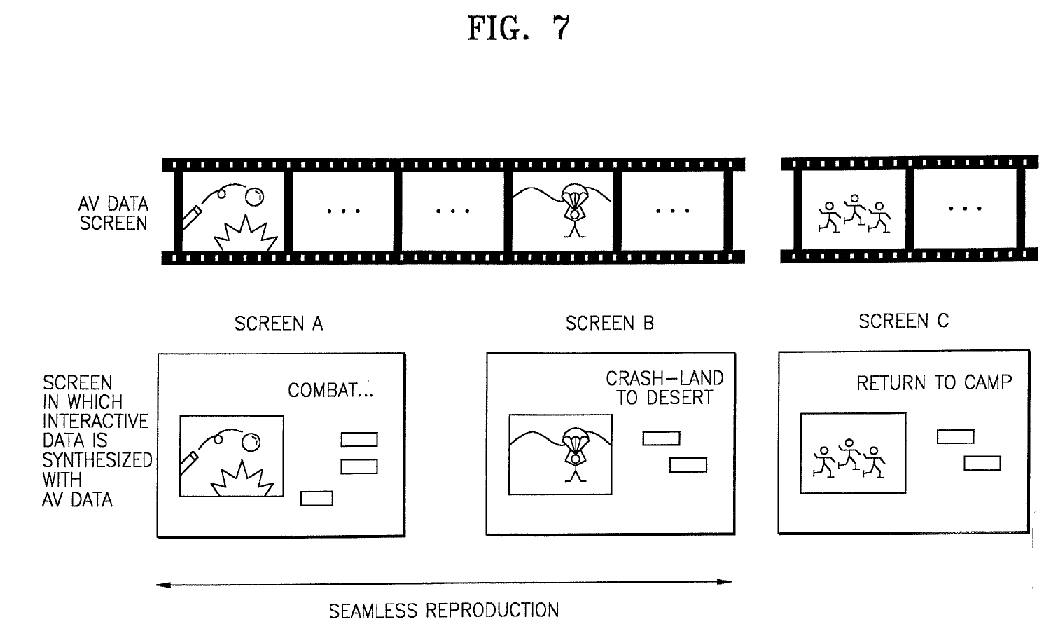

FIG. 7 is an example of the interactive data screens (output screens) A, B, and C. An example of the file A.HTM for providing information of the interactive data screen A is as follows.

<?xml version=“1.0” encoding=“UTF-8” ?>
<!DOCTYPE html PUBLIC -//DVD//DTD XHTML DVD-HTML 1.0//EN”
“http://www.dvdforum.org/enav/dtd/dvdhtml-1-0.dtd”>
<html>
<head>
<title> Combat...</title>
<link rel=“preload” src=“dvd://dvd_enav/kor/b.pld”/>
</head>
.
.
.
<p align=“center”><font size=“5” face“kor-gulim”>Combat... </FONT</P>
</body>
</html>

The font size “5” of kor-gulim and a screen, which is aligned at the center of the screen and is output as “Combat . . . ”, are provided (<p align=“center”><font size=“5” face=“kor-gulim”>Combat . . . ). The file A.HTM provides a path of the file B.PLD having the preloaded information of data of the screen B, which is to be linked and seamless-reproduced after the screen A (<link rel=“preload”src=“dvd://dvd_enav/kor/b.pld”/>).

An example of the file B.PLD having preloaded information of data of the screen B is as follows.

<?xml version“1.0”? encoding=“UTF-8”?>
<!DOCTYPE preload PUBLIC “-//DVD//DTD DVD Preload List 1.0//EN”
“http://www.dvdforum.org/enav/dtd/dvdhtml-preload-list.mod”>
<preload cachesize=“1500KB”>
<filedef type=“text/xml” src=“dvd://dvd_enav/kor/b.htm”/>
<filedef type=“image/png” src=“dvd://dvd_enav/kor/b1.png”/>
<fontdef id =“A48000D0B7DB671A” font-family=“dotum;arial”
font-style=“normal” font-variant=“normal” font-weight=“normal”
font-stretch=“normal” font-size=“all” font-range=“U+0100−0220”
type=“application/dvd.pfr” src=“dvd://dvd_enav/kor/b1.pfr”/>
</preload>

The file B.PLD preloaded from the file A.HTM reads the above information. The size of a memory required for the interactive optical storage medium to be prepared when preloading is “1500 KB”. The file B.HTM as a data file for constituting the screen B, and the font B1.PFR, which is to be used in the screen B, is preloaded into the memory. The path of files to be preloaded is provided like “dvd://dvd_enav/kor/b.htm”, “dvd://dvd_enav/kor/b1.png ”, and “dvd://dvd_enav/kor/b1.pfr”.

Like an information file fontdef id=“A48000D0B7DB671A”, the above information files include an attribute of a <fontdef> element, which defines a unique identifier (ID) of a predetermined font. The apparatus for reproducing data from the interactive optical storage medium searches for a font having an ID, which is identical to the identifier (ID) of the font mentioned in the <fontdef> element, from a resident font database. When there is no font that is identical with the ID in the apparatus, the apparatus tries to takes a font from a web server or an optical information storage medium by using an “src” attribute of <fontdef> element.

However, when a font that is identical to the ID cannot be found, the apparatus takes another font within a font-range of <fontdef> element. The font-range attribute of <fontdef> element defines a font-range as a position of a letter code, which is stipulated according to an ISO 10646 standard. The font-range is represented as a hexadecimal number started from a prefix “U+”. For example, U+05D1 corresponds to “Hebrew letter bet” of the letter code stipulated according to the ISO 10646 standard. Likewise, by designating the font-range declaring the range of a font to be preloaded, the apparatus can preload only a font that is essential for reproduction. Using “-” and “,” the font-range may be defined consecutively or inconsecutively below.

Example 1) font-range=“U+AC00-D7FF”; Font-range is defined from AC00 to D7FF.

Example 2) font-range=“U+0370-03FF, U+1 F00-1 FFF”; Font-range is defined from 0370 to 03FF (modern Greek) and from 1F00 to 1 FFF(polytonic Greek).

The attributes of <fontdef> element, such as font-family, font-style, font-variant, font-weight, font-stretch, and font-size, is additional attribute information that is provided so that the most similar font to be displayed on a screen can be found when a font that is identical with the above-mentioned font family cannot be found. In other words, when there is no font that is most suitable for specifications intended by a content manufacturer, a font that can be replaced and displayed on the screen is searched and displayed on the screen, using additional information when preloading of the font.

Since the data file and font file of the screen B have been already loaded into the memory of the apparatus when the screen B and the A/V data are seamlessly reproduced at the time when the screen A is output from the file A.HTM and defined, time required to load files for use in outputting the screen B can be reduced. Thus, an interruption of seamless reproducing the A/V data of the screen can be prevented.

An example of the file B.HTM for providing information of the screen B is as follows.

<?xml version=“1.0” encoding=“UTF-8” ?>
<!DOCTYPE html PUBLIC -//DVD//DTD XHTML DVD-HTML 1.0//EN”
“http://www.dvdforum.org/enav/dtd/dvdhtml-1-0.dtd”>
<html>
<head>
<title> Crash-land to desert</title>
<link rel=“preload” src=“dvd://dvd_enav/kor/b.pld”/>
<script type=“text/ecmascript”>
<![CDATA[
function font_discard( )
{

navigator.Discard(“src:dvd://dvd_enav/lor/b1.pfr”); //B1 font is not used any more //font can

be removed from the memory.
}
[[>
</script>
</head>
<body unload=“font_discard( )”>
.
.
.
<p align=“center”><font size=“5” face=“dotum”> Crash-land to desert</font></p>
</body>
</html>

The file B.HTM provides a screen displayed as “Crash-land to desert”. Since the font B1.PFR corresponding to “dotum” has been already loaded into the memory of the apparatus when the screen A is output from the file B.HTM, a separate loading operation and time required therefor are unnecessary. Thus, the seamless reproduction without an interruption caused by fonts loading can be guaranteed during output of the screen B, which is performed simultaneously with reproduction of the A/V data. When the output of the screen B is terminated, the file B.HTM can include a command font_discard for removing the font B1.PER in order to relieve burden applied to a memory capacity due to the font B1.PFR. Even though “navigator.Discard(“src:dvd://dvd_enav/lor/b1.pfr”)” is used as an example of a command to remove a font in the above-mentioned code table, the corresponding font may be removed by simply mentioning only the font ID defined in the above-mentioned example of ILD_FONT.PLD. A code having the above-mentioned function may be described below.

Example)

function font_discard( )
{
navigator.Discard(“id:CBAEFOC1B42F11d5A48000D0B7DB671A”, application/dvd.pfr”;
}

Last, an example of the file C.HTM as a data file constituting the screen C, is as follows.

<?xml version=“1.0” encoding=“UTF-8” ?>
<!DOCTYPE html PUBLIC -//DVD//DTD XHTML DVD-HTML 1.0//EN”
“http://www.dvdforum.org/enav/dtd/dvdhtml-1-0.dtd”>
<html>
<head>
<title>Return to Camp</title>
<link rel=“preload” src=“dvd://dvd_enav/kor/c.pld”/>
<script type=“text/ecmascript”>
<![CDATA[
function font_discard( )
{

navigator.Discard(““dvd://dvd_enav/kor/c1.pfr”); //C1 font is not used any more//font can be

removed from the memory.
}
]]>
</script>
</head>
<body unload=“font_discard( )”>
.
.
.
<p align=“center”><font size=“5” face=“kgothic”>Return to camp</font></p>
</body>
</html>

The file C.HTM provides a screen displayed as “Return to camp”. “Kgothic”, which is to be used for outputting the screen C, relates to the file C1.PFR, and thus is preloaded when a preload command is performed by a file C.PLD (not shown). However, since the screen C is not seamless-reproduced, the interruption of the seamless reproduction from the previous screen B caused by time required for preloading the fonts is prevented. When the output of the screen C is terminated, a command font_discard for removing a font may be performed in the file C.HTM in order to relieve burden applied to a memory capacity of the apparatus. Here, even in the command font_discard, like the above-mentioned code example, besides a method of removing the whole file by searching a file having fonts, there may be another method of removing a corresponding font by including only a font identifier (ID) in the command font_discard.

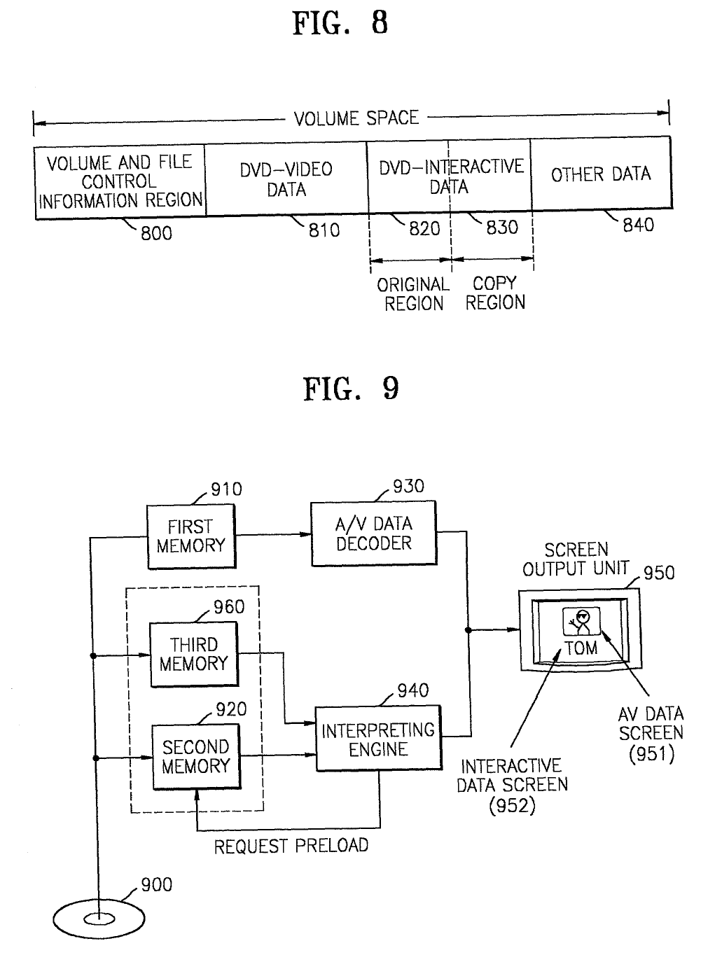

FIG. 8 illustrates a structure of a volume space of the interactive optical storage medium having the preloaded font information. Referring to FIG. 8, the interactive optical storage medium includes a control information region 800 in which the control information of the interactive optical storage medium is recorded, a video data region 810 in which the A/V data and the reproduction information for reproducing the A/V data are recorded, an interactive data region 820 in which the above-mentioned preloaded font interactive information is recorded, and an interactive data-copying region 830 in which data of the interactive data region 820 are stored repeatedly to compensate for damage in the interactive data region 820. The interactive optical storage medium can further include another region in which product information or user's information is recorded.

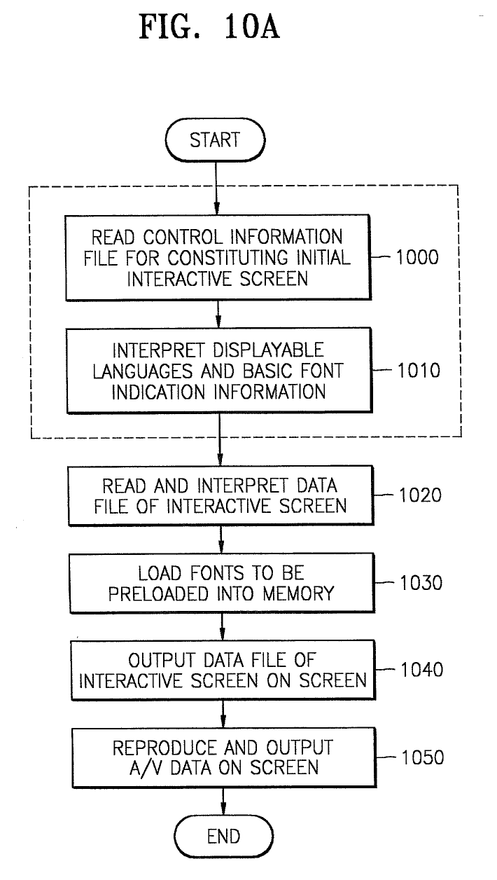

FIG. 9 illustrates a reproducing apparatus reproducing the interactive optical storage medium having preloaded font information according to another embodiment of the present invention. Referring to FIG. 9, the interactive optical storage medium 900 includes information for controlling the interactive data screen, which preloads fonts of a screen to be seamless-reproduced, data for controlling an output screen, and interactive data and A/V data, which are to be reproduced.

A first memory 910 buffers the A/V data, which are compressed and read from the interactive optical storage medium 900.

A second memory 920 stores the interactive data read from the interactive optical storage medium 900, and takes and stores the fonts included in the interactive optical storage medium 900, when a request for preloading a predetermined font is received from an interactive data-interpreting engine 940.

An A/V data decoder 930 decodes the A/V data stored in the first memory 910. The interactive data-interpreting engine 940 interprets HTMLs, JAVA scripts applet, and fonts, which are used for interpreting the interactive data read from the second memory 920 or a third memory 960. When a command to preload the interactive data is included in the interactive data-interpreting engine 940, the interactive data-interpreting engine 940 preloads the interactive data into the second memory 920.

A screen output unit 950 synthesizes and outputs information interpreted by the A/V data decoder 930 and by the interactive data-interpreting engine 940. A screen output unit 950 provides a screen which is similar to the shape (frame) of a web browser including an A/V data screen region 951 in which the decoded A/V data are reproduced, and an interactive data screen region 952 in which network searching and linking operations and an interactive operation are performed.

Fonts, which are resident (implemented) in the apparatus for reproducing information from the interactive optical storage medium 900, and the basic fonts, which are initially loaded by the interactive optical storage medium 900, are stored in the third memory 960. When the preloaded fonts requested by the interactive data-interpreting engine 940 are not included in the second memory 920, the basic fonts included in the third memory 960 are transferred to the interactive data-interpreting engine 940. In such a case, when there are no fonts requested by the third memory 960, the basic fonts belonging to the same family of the requested and preloaded fonts are transferred to the interactive data-interpreting engine 940.

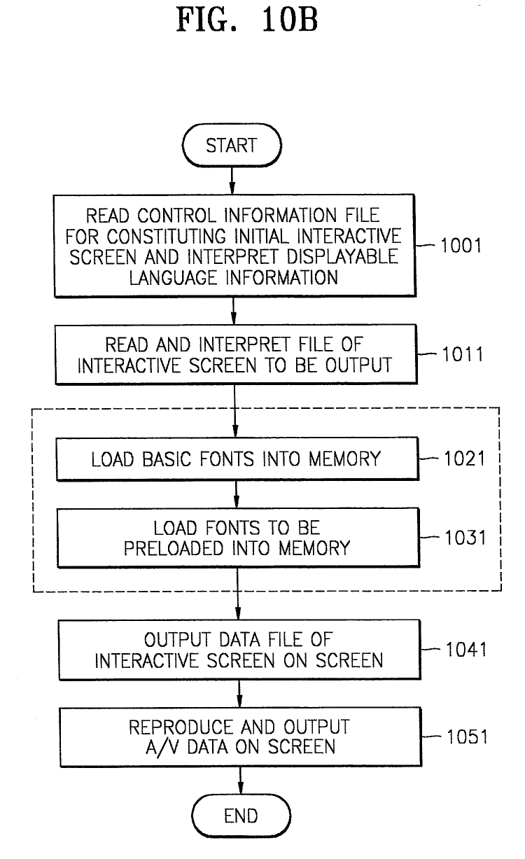

FIG. 10A is a flow chart illustrating a method of operating the interactive optical storage medium having the preloaded font information according to another embodiment of the present invention.

In operation 1000, a file (i.e., the above-mentioned DVD_ENAV.IFO) having control information to form an initial interactive screen is read from the interactive optical storage medium. In 1010, the basic fonts are loaded into a memory (i.e., the third memory 960 of FIG. 9) of the apparatus for reproducing information from the interactive optical storage medium according to displayable languages and the basic font indication information.

In operation 1020, a data file of a defined interactive screen is read. In 1030, an indicated preload file is read, and fonts defined in the preload file are loaded into the second memory 920 of the apparatus when a preload command is included in the data file of the interactive screen. In operation 1040, the apparatus checks whether there is the same font as a font identifier (ID) when the fonts defined are loaded in the preload file, and then the apparatus loads the font having the same ID as the font ID into the second memory. Also, the apparatus can load only a font within a corresponding font-range into the second memory by referring the font-range defined in the preload file. After the font is preloaded, the data file corresponding to the interactive screen in operation 1020 is output on the interactive data screen. In operation 1050, the A/V data are reproduced and output on the interactive screen. A font-discard command in the data file may be performed to discard a corresponding font from the second memory of the apparatus. The font-discard command is performed by discarding a corresponding font file or by removing a font having the same ID using a font identifier (ID).

FIG. 10B is a flow chart illustrating another method of operating the interactive optical storage medium having the preloaded font information according to another embodiment of the present invention.

In operation 1001, a file (i.e., the above-mentioned DVD_ENAV.IFO) having control information to form an initial interactive screen is read from the interactive optical storage medium. In operation 1011, the data file of the interactive screen to be output is read and interpreted. In operation 1021, the basic fonts stored in the interactive optical storage medium are loaded into the memory of the apparatus for reproducing information from the interactive optical storage medium. In operation 1031, the fonts to be preloaded are loaded into the memory of the apparatus.

In operation 1041, the apparatus checks whether a font having the same ID as a font identifier (ID) to be preloaded has been already loaded into the memory and has been stored in the memory. If there is no font having the same ID as the font identifier (ID) to be preloaded, has not been already loaded into the memory, and has not been stored in the memory, the apparatus will reload a corresponding font into the memory. Also, the apparatus can load a font within the corresponding font-range into the second memory by referring the font-range defined in the preload file. After the font is preloaded, the data file corresponding to the interactive screen is output on the interactive data screen. In operation 1051, the A/V data are reproduced and output on the interactive screen. A font-discard command in the data file may be performed to discard a corresponding font from the memory of the apparatus. The font-discard command is performed by discarding the corresponding font file or by removing a font having the same ID using a font identifier (ID).

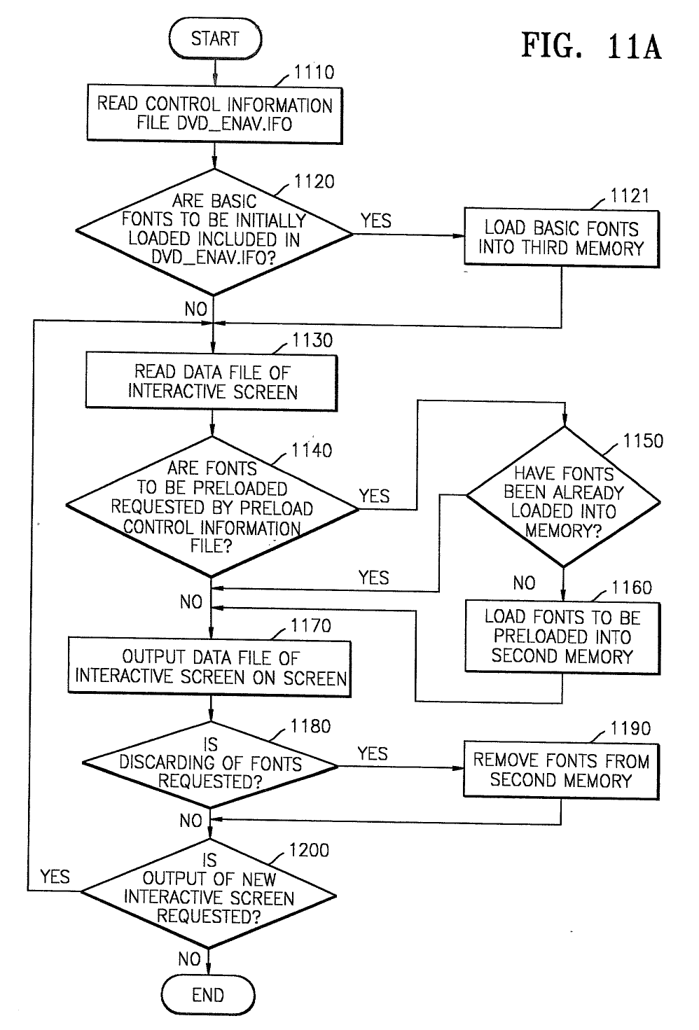

FIG. 11A is a detailed view of FIG. 10A and a flow chart illustrating a method of loading fonts stored in the interactive optical storage medium into the reproducing apparatus for reproducing information from the interactive optical storage medium.

Referring to FIGS. 5 through 7 and 11A, in operation 1110, the file DVD_ENAV.IFO having control information for constituting an initial interactive screen is read from the interactive optical storage medium. In operation 1120, it is checked whether the basic fonts to be initially loaded are included in the control information file. In operation 1121, the basic fonts are loaded into the third memory 960 of FIG. 9 when the basic fonts to be initially loaded are included in the control information file. In operation 1130, the data file of the defined interactive screen is read when the basic fonts to be initially loaded are not included in the control information file in step 1120 and after operation 1121.

In operation 1150, it is checked using a font ID whether corresponding fonts have been already loaded into the second memory 920 when preload information are included in the data file of the interactive screen and fonts to be preloaded are requested by the preload control information file in step 1140. In 1160, the fonts are loaded into the second memory 920 when the fonts have been not loaded into the memory as the result of checking in operation 1150. The apparatus can load a font within a corresponding range into the second memory by referring the font-range defined in the preload file. In operation 1170, the data file of the interactive screen is output on the interactive data screen when fonts to be preloaded are not requested by the preload control information file after operation 1160 or in operation 1140.

In operation 1190, the fonts are removed from the second memory 920 when discarding of the fonts stored in the second memory 920 is requested in operation 1180. The font-discard command is performed by discarding a corresponding font file or by removing a font having the same ID using a font identifier (ID). The above-mentioned operation is repeated with operation 1130 when discarding of the fonts is not requested, or when output of a new interactive screen is requested after the fonts are removed from the second memory in operation 1200.

FIG. 11B is a detailed view of FIG. 10B and a flow chart illustrating a method of loading the fonts stored in the interactive optical storage medium into the reproducing apparatus for reproducing the information from the interactive optical storage medium.

Referring to FIGS. 5 through 7 and 11B, in operation 1111, the file DVD_ENAV.IFO having control information for constituting an initial interactive screen is read from the interactive optical storage medium. In operation 1121, the data file of a defined interactive screen is read. In step 1131, it is checked whether an embedded font @font_face in the specification of a cascading style sheet 2 (CSS 2) related to the web document is included in the data file (HTML document file) of the interactive screen. In operation 1141, the embedded font @font_face is loaded into the third memory 960 of FIG. 9 when the embedded font @font_face is included in the data file.

In operation 1151, it is checked whether the preloaded control information file in the data file of the interactive screen requests preloading of fonts. In operation 1161, corresponding fonts are preloaded into the second memory 920 of FIG. 9 when the fonts are requested to be preloaded by the preloaded control information file and the same fonts have been not loaded into the memory in operation 1162. The apparatus checks whether there is the same font as the font identifier (ID) when the fonts defined are loaded in the preload file, and then the apparatus loads the font having the same ID as the font ID into the second memory 920. When there is no font having the same ID as the font ID, the apparatus can load a font within a corresponding range into the second memory 920 by referring to the font-range defined in the preload file.

In operation 1171, the data file of the interactive screen is output on a screen when fonts to be preloaded are not requested by the preload control information file in operation 1151, or when the same fonts have been already loaded into the second memory 920 of the apparatus, or after step 1161. In operation 1191, the fonts are removed from the second memory 920 when discard of the fonts stored in the second memory 920 is requested in operation 1181. The font-discard command is performed by discarding a corresponding font file or by removing a font having the same ID using the font identifier (ID). The above-mentioned operation is repeated from operation 1131 when the discarding of the font file or the removing of the font is not requested, or when output of a new interactive screen is requested after the fonts are removed from the second memory 920 in operation 1201.

As described above, the font of the interactive screen can be the same as that of a language (caption) used in a video screen of the interactive screen displaying a video picture corresponding to the A/V data. Before a font used in a current interactive screen is changed to another font to be used in a next interactive screen, another font is preloaded into the memory before the next interactive screen replaces the current interactive screen while the video picture continues to be seamlessly displayed in both current and next interactive screen, thereby guaranteeing the seamless reproduction of the A/V data, which is simultaneously reproduced with the interactive screens.

It is possible that the font of the interactive screen is different from that of the language, such as a caption, of the video picture of the AV data.

Although a few preferred embodiments of the present invention have been shown and described, it would be appreciated by those skilled in the art that changes may be made in this embodiment without departing from the principles and spirit of the invention, the scope of which is defied in the claims and their equivalents.

What is claimed is:

1. An interactive optical storage medium read and executed by a reproducing apparatus having a memory, comprising:
A/V data including audio or video data; and
interactive data forming an interactive screen, allowing the apparatus to display a video picture of the A/V data in the interactive screen, and preload fonts relating to a content of the interactive screen into the memory of the reproducing apparatus during displaying a seamless video picture.

2. The medium of claim 1, wherein the interactive data are a web-based document.

3. The medium of claim 1, wherein the interactive data comprises a command to control the apparatus to preload font data corresponding to fonts of the content of the interactive screen and to display the content in one of the fonts and the video picture into the interactive screen during displaying the seamless video picture.

4. The medium of claim 3, wherein the interactive data comprises preload information having a font identifier (ID) of a font to be preloaded when the command is performed to preload the font data.

5. The medium of claim 3, wherein the interactive data comprises preload information having a font-range of a font to be preloaded when the command is performed to preload the font data.

6. The medium of claim 5, wherein the font-range of the font is defined using a letter code which is stipulated according to an ISO 10646 standard.

7. The medium of claim 3, wherein the interactive data comprises preload information having attribute information of a font to be preloaded when the command is performed to preload the font data.

8. The medium of claim 7, wherein the attribute information of the font includes a combination of a font-family (representing a group in which the font is included, and a font name), a font-style (representing the style of the font), a font-variant (representing whether or not the font can be represented as a bold type), a font-weight (representing the thickness of the font), a font-stretch (representing the aspect ratio of the font), and a font-size (representing the size of the font).

9. The medium of claim 1, wherein the interactive data comprises a discard command to remove a loaded font from the memory.

10. The medium of claim 9, wherein the discard command is a command to designate a path and name of a font file and to remove the path and the name of the font file.

11. The medium of claim 9, wherein the discard command is a command to generate a font ID and remove a font having the same ID as the font ID.

12. An interactive optical storage medium read and executed by a reproducing apparatus having a memory, comprising:
an A/V data region in which audio or video (AV) data is recorded;
an interactive data region in which interactive data forming an interactive screen and allowing the apparatus to display a video picture corresponding to the A/V data in the interactive screen and preload font data representing fonts relating a content of the interactive screen into the memory of the reproducing apparatus during seamlessly reproducing the AV data; and
an interactive data-copying region in which the same data as interactive data information region are stored to compensate for damages in the interactive data.

13. The medium of claim 12, wherein the interactive data is a web-based document.

14. The medium of claim 12, wherein the interactive data includes a command to control the apparatus to preload font data corresponding to the fonts of the interactive screen and to display the content in one of the fonts and the video picture in the interactive screen during reproducing a seamless video picture of the AV data.

15. The medium of claim 14, wherein the interactive data comprises preload information having a font identifier (ID) of a font to be preloaded when the command is performed to preload the font data.

16. The medium of claim 14, wherein the interactive data comprises preload information having a font-range of a font to be preloaded when the command is performed to preload the font data.

17. The medium of claim 16, wherein the font-range of the font is defined using a letter code which is stipulated according to an ISO 10646 standard.

18. The medium of claim 14, wherein the interactive data comprises preload information having attribute information of a font to be preloaded when the command is performed to preload the font data.

19. The medium of claim 18, wherein the attribute information of the font includes a combination of a font-family (representing a group in which the font is included, and a font name), a font-style (representing the style of the font), a font-variant (representing whether or not the font can be represented as a bold type), a font-weight (representing the thickness of the font), a font-stretch (representing the aspect ratio of the font), and a font-size (representing the size of the font).

20. The medium of claim 12, wherein the interactive data comprises preload information having a discard command to remove a loaded font from the memory.

21. The medium of claim 20, wherein the discard command is a command to designate a path and name of a font file and remove the path and the name of the font file if used.

22. The medium of claim 20, wherein the discard command comprises a font ID and controls the apparatus to remove a font having the same ID as the font ID.

23. An apparatus for reproducing data from an interactive optical storage medium to generate an interactive screen, the apparatus comprising:
a first memory storing A/V data read from the interactive optical storage medium;
a second memory storing interactive data having fonts and font preload information read from the interactive optical storage medium;
an A/V data decoder decoding the A/V data stored in the first memory to be displayed in the interactive screen; and
an interpreting engine interpreting the interactive data from the second memory and outputting the interpreted interactive data in one of the fonts on the interactive screen;
wherein the second memory receive the fonts from the interactive optical storage medium and stores the fonts when the interpreting engine requests the second memory to preload the fonts.

24. The apparatus of claim 23, further comprising a third memory having basic fonts of the apparatus, wherein the preloaded fonts are replaced with the basic fonts, and one of the basic fonts is output on the interactive screen by the interpreting engine when there are no fonts preloaded into the second memory.

25. The apparatus of claim 23, wherein the interactive data includes a preload command to preload font data representing the fonts to be used in a subsequent interactive screen replacing a current interactive screen during reproducing a seamless A/V data.

26. The apparatus of claim 25, wherein the command to preload the font data provides a font ID in the preload information of the interactive data, and the interpreting engine determines whether a font having the same ID as the font ID has been already loaded into the second memory.

27. The apparatus of claim 26, wherein the command preload the font data provides a font-range of a font to be preloaded in the preload information and allows the interpreting engine to preload a font within the font-range.

28. The apparatus of claim 27, wherein the font-range of the font is defined using a letter code which is stipulated according to an ISO 10646 standard.

29. The apparatus of claim 23, wherein the interactive data comprises a discard command to remove a loaded font from the second memory, and the interpreting engine removes a corresponding font from the second memory in response to the discard command.

30. The apparatus of claim 29, wherein each of the fonts comprises a font file having a path and a name, and the interpreting engine removes the corresponding font by discarding the path and name of the font file to be removed according to the discard command.

31. The apparatus of claim 29, wherein each of the fonts each comprises an ID font, and the interpreting engine removes the corresponding font by discarding a font having the same ID as the font ID to be removed according to the discard command.

32. The apparatus of claim 23, wherein the interpreting engine interprets HTMLs or JAVA scripts.

33. The apparatus of claim 23, wherein the interactive data is a web-based document.

34. The apparatus of claim 23, wherein the A/V data decoder is a moving picture experts group (MPEG) decoder which decodes A/V data compressed in a format of MPEG.

35. The apparatus of claim 23, wherein one of the fonts stored in the second memory according to the preload command, is used in a subsequent screen replacing a current interactive screen.

36. A system for reproducing data from an interactive optical storage medium and generating an interactive screen in a reproducing apparatus, the system comprising:
an interactive optical storage medium on which A/V data and interactive data having a preload command are recorded;
a first memory storing the AV data read from the interactive optical storage medium;
a second memory storing the interactive data read from the interactive optical storage medium;
a decoder decoding the A/V data from the first memory;
an interpreting engine interpreting the interactive data from the second memory and providing interactive screen data; and
a screen output unit synthesizing the A/V data received from the decoder, with the interactive screen data to form the interactive screen;
wherein the second memory stores fonts to be preloaded from the interactive optical storage medium when the interpreting engine requests the second memory to preload the fonts in response to the preload information.

37. The system of claim 36, further comprising a third memory storing fonts of the reproducing apparatus and basic fonts of the interactive optical storage medium, and the basic fonts are used in the interactive screen by the interpreting engine when there are no fonts of the reproducing apparatus preloaded into the second memory.

38. The system of claim 37, wherein the interactive optical storage medium further includes basic embedded font information corresponding to the basic fonts, and the basic embedded font information is loaded into the third memory.

39. The system of claim 36, wherein the interactive data includes a command to preload font data corresponding to the fonts one of which is used in a subsequent interactive screen replacing a current interactive screen during reproducing a seamless A/V data in the current and subsequent interactive screen.

40 The system of claim 39, wherein the command to preload the font data comprises a font ID in the preload information, and the interpreting engine determines whether a font having the same ID as the font ID has been already loaded into the second memory.

41. The system of claim 39, wherein the command to preload the font data comprises a font-range of a font to be preloaded in the preload information and allows the interpreting engine to preload a font within the font-range.

42. The system of claim 41, wherein the font-range of the font is defined using a letter code which is stipulated according to an ISO 10646 standard.

43. The system of claim 36, wherein the interactive comprises a discard command to remove a preloaded font in the second memory, and the interpreting engine removes a corresponding font from the second memory in response to the discard command.

44. The system of claim 43, wherein the preloaded font comprises a font file having a path and name, and the interpreting engine removes the corresponding font by discarding the path and name of the font file to be removed according to the discard command.

45. The system of claim 43, wherein the interactive data comprises a font ID corresponding to respective one of the fonts, and the interpreting engine removes the corresponding font by discarding a font having the same ID as the font ID to be removed according to the discard command.

46. The system of claim 36, wherein the interpreting engine interprets HTMLs or JAVA scripts.

47. The system of claim 36, wherein the interactive data are a web-based document.

48. The system of claim 36, wherein the A/V data decoder is a moving picture experts group (MPEG) decoder, which decodes A/V data compressed in a format of MPEG.

49. The system of claim 36, wherein the fonts stored in the second memory according to the preload command, are fonts to be used in a subsequent screen replacing a current interactive screen.

50. The system of claim 36, wherein the interpreting engine is connected to an Internet server, and the interactive screen formed by the screen output unit comprises a moving picture screen region in which the decoded A/V data are reproduced, and an interactive screen region in which network searching and/or linking operations and an interactive operation are performed through the Internet server.

51. A method of reproducing data from an interactive optical storage medium in a reproducing apparatus having a memory, the method comprising:
reading a control information file having control information to form an interactive screen and preload font information from the interactive optical storage medium;
reading a data file of the interactive screen;
reading a preload file when a preload command is included in the data file of the interactive screen and preloading the fonts, which are defined by the preload file representing displayable language of the interactive screen into the memory of the reproducing apparatus;
outputting the interactive screen in one of the preloaded fonts according to the data file of the interactive screen; and
synthesizing an A/V data screen in which A/V data is reproduced, with the interactive screen in the one of the preloaded fonts.

52. The method of claim 51, wherein the preload command to preload font data of the fonts provides a font ID to the preload font information to determine whether a font having the same ID as the font ID has been already loaded into the memory of the reproducing apparatus.

53. The method of claim 51, wherein the preload command to preload font data of the fonts provides a font-range of a font to be preloaded to the preload font information to preload a font within the font-range.

54. The method of claim 53, wherein the font-range of the font is defined using a letter code which is stipulated according to an ISO 10646 standard.

55. The method of claim 51, further comprising removing a corresponding font from the second memory when the interactive data includes a discard command to remove a loaded font.

56. The method of claim 55, wherein the preload font information comprise a font file having a path and a name of each font to be preloaded, and the path and name of the font file to be removed are searched and removed according to the discard command.

57. The method of claim 55, wherein the fonts each has a font ID, and a font having the same ID as the font ID to be removed is searched and removed according to the discard command.

58. A method of reproducing data stored in an interactive optical storage medium in a reproducing apparatus having a memory, the method comprising:
reading interactive data forming an interactive screen and having a data file from the interactive optical storage medium;
checking whether a preload command is included in the data file of the interactive data, reading fonts to be preloaded from the interactive optical storage medium in response to the preload command, and preloading the read fonts into the memory of the reproducing apparatus when the fonts to be preloaded are included in the data file of the interactive data;
outputting the interactive screen of the interactive data; and
removing the preloaded font from the memory when the preloaded font is requested to be discarded by the interactive data.

59. The method of claim 58, wherein the preload command to preload font data of the fonts provides a font ID to determine whether a font having the same ID as the font ID has been already loaded into the memory of the reproducing apparatus.

60. The method of claim 58, wherein the preload command to preload font data of the fonts provides a font-range of a font to be preloaded to preload a font within the font-range.

61. The method of claim 60, wherein the font-range of the font is defined using a letter code which is stipulated according to an ISO 10646 standard.

62. The method of claim 58, wherein the fonts each comprises a font file having a path and a name, and the removing of the fonts comprises searching the path and name of the font file to be removed and removing them from the memory.

63. The method of claim 58, wherein the fonts each comprises a font ID, and the removing of the preloaded font comprising discarding a font having the same font ID as the preloaded font to be removed and removing the corresponding font from the memory.

64. The method of claim 58, wherein the preload command is read from the interactive optical storage medium before the interactive screen to be seamlessly reproduced is output.

65. An interactive optical storage medium having interactive data and AV data, comprising:
a first table which defines displayable interactive languages of an interactive screen formed by the interactive data when the interactive screen of the interactive data is output;
a second table, which defines A/V languages used in an A/V screen of the A/V data in the interactive screen; and
a third table which defines basic fonts to be used by the displayable interactive languages defined by the first table.

66. The medium of claim 65, wherein the second table comprises control information which automatically selects one of the displayable interactive languages defined by the first table when a first language to be used in the A/V screen of the A/V data and a second language to be used in the interactive screen of the interactive data are not defined.

67. A reproducing apparatus for reproducing data from an interactive storage medium, comprising:
a memory storing A/V data and interactive data forming an interactive screen; and
an engine determining whether the interactive data includes preload fonts information relating to fonts of displayable interactive languages used in the interactive screen, controlling the memory to preload the fonts in response to the preload fonts information.

68. The reproducing apparatus of claim 67, further comprising a reader reading data from the interactive storage medium, and the engine controls the reader to read the fonts from the interactive storage medium and the memory to store the read fonts.

69. The reproducing apparatus of claim 67, wherein the engine generates the interactive screen in one of the fonts stored in the memory.

70. The reproducing apparatus of claim 67, wherein the interactive screen comprises an A/V screen and an interactive content screen, and a video image corresponding to the A/V data is displayed in the A/V screen while a content of the interactive data is displayed in the interactive content screen in one of the fonts.

71. The reproducing apparatus of claim 70, wherein the content displayed in the interactive content screen comprises a first interactive content screen and a second interactive content screen both formed by the interactive data, and the fonts comprises a first font and a second font, the engine generating the first interactive content screen in the first font of the fonts and the second interactive content screen in the second font of the fonts.

72. The reproducing apparatus of claim 71, wherein the first interactive content screen and the second interactive are seamlessly displayed.

73. The reproducing apparatus of claim 70, wherein the apparatus receives a caption relating to the video image of the AV data to be displayed together with the video image in the A/V screen of the interactive screen, and the content of the interactive data is displayed in the interactive content screen of the interactive screen in one of the fonts different from that of the caption.

74. The reproducing apparatus of claim 70, wherein the apparatus receives a caption relating to the video image of the A/V data to be displayed together with the video image in the A/V screen of the interactive screen, and the content of the interactive data and the caption is displayed in one of the fonts in the A/V screen and the interactive content screen of the interactive screen, respectively.

75. A method in an reproducing apparatus having a memory and reproducing data from an interactive storage medium, comprising:
storing A/V data and interactive data forming an interactive screen having an A/V screen and an interactive content screen;
determining whether the interactive data includes preload font information relating to fonts of displayable interactive languages used in the interactive screen; and
controlling the memory to preload the fonts in response to the preload font information to display the interactive screen using one of the fonts.

76. The method of claim 74, wherein the controlling of the memory comprises reading the fonts from the interactive storage medium and storing the read fonts in the memory.

77. The method of claim 74, wherein a video image corresponding to the A/V data is displayed in the A/V screen, and a content of the interactive data is displayed in the interactive content screen in one of the fonts.

78. The method of claim 76, wherein the interactive content screen comprises a first interactive content screen and a second interactive first interactive content screen, and the method further comprises displaying the second interactive content screen and the second interactive content screen in a first font and a second font of the fonts, respectively.

79. The method of claim 76, wherein the apparatus receives a caption relating to the video image of the A/V data to be displayed together with the video image in the A/V screen of the interactive screen, and the method comprises displaying the caption in the A/V screen of the interactive screen and displaying the content of the interactive data in the interactive content screen of the interactive screen in one of the fonts different from that of the caption.

80. The reproducing apparatus of claim 76, wherein the apparatus receives a caption relating to the video image of the A/V data to be displayed together with the video image in the A/V screen of the interactive screen, and the method further comprises displaying the content of the interactive data and the caption in one of the fonts in the A/V screen and the interactive content screen of the interactive screen, respectively.

81. A method in an reproducing apparatus having a memory and reproducing data from an interactive storage medium, comprising:
storing A/V data and interactive data in the memory;
determining whether the interactive data includes preload fonts information relating to fonts of displayable interactive languages;
controlling the memory to preload the fonts in response to the preload fonts information; and
seamlessly generating an interactive screen in response to the A/V data and the interactive data during displaying the interactive screen in one of the fonts.

82. The method of claim 82, wherein the interactive screen comprises an A/V screen and a content screen, and the generating of the interactive screen comprises seamlessly generating the A/V screen and the content screen during changing the interactive screen from a first font of the fonts to a second font of the fonts without requiring loading the fonts.
